(19) United States
(12) Patent Application Publication
(10) Pub. No.: US 2025/0150344 A1
(43) Pub. Date: May 8, 2025

(54) MANAGEMENT SYSTEM, MANAGEMENT METHOD, AND MANAGEMENT PROGRAM

(71) Applicant: Nippon Telegraph and Telephone Corporation, Tokyo (JP)

(72) Inventors: Yasuyuki NIIHARA, Musashino-shi, Tokyo (JP); Atsushi SUTO, Musashino-shi, Tokyo (JP); Shinji ABE, Musashino-shi, Tokyo (JP); Hiroki INOUE, Musashino-shi, Tokyo (JP); Hiroki HOSONO, Musashino-shi, Tokyo (JP)

(21) Appl. No.: 18/837,617

(22) PCT Filed: Feb. 22, 2022
(86) PCT No.: PCT/JP2022/007317

§ 371 Date: Aug. 12, 2024

(51) Int. Cl. H04L 41/0866; G06F 16/25; H04L 41/0803

(52) U.S. Cl. CPC H04L 41/0866; G06F 16/254; H04L 41/0803

(57) ABSTRACT

A management system includes a conversion device including a first extraction unit that extracts setting content as first summary information for each NW function from first setting data for setting an operation of a migration source NW device, and a conversion unit that converts a system of the first setting data for setting an operation of the migration source NW device into second setting data according to a system of setting data of a migration destination NW device and applies the second setting data to the migration destination NW device, and a checking device including a determination unit that determines whether or not migration of the first setting data to the migration destination NW device has been performed normally on the basis of the first summary information and third setting data applied to the migration destination NW device.

### TECHNICAL FIELD

The present invention relates to a management system, a management method, and a management program.

### BACKGROUND ART

Migration of a network (NW) device requires migration of setting information of an old device and route switching. As migration of setting information of a device, there are a process of extracting the setting information (configuration data) of a migration source NW device and converting the setting information into setting information for a migration destination NW device, and a process of applying the configuration data to the migration destination device.

When a difference in device configuration occurs between the migration source NW device and the migration destination NW device, a delay in service start of a customer user, a failure in service provision, or the like occurs. Therefore, it is necessary to check that there is no error in configuration data before and after migration.

Here, conventionally, a method related to migration of a database and conversion of data at the time of migration has been proposed.

### CITATION LIST

### Patent Literature

Patent Literature 1: JP 2011-049695 A
Patent Literature 2: JP 2015-222465 A
Patent Literature 3: JP 2015-153344 A

### SUMMARY OF INVENTION

### Technical Problem

In the conventional method, in order to check whether data has been correctly ported, the equivalence check of a database before and after migration is performed by checking whether element values of a data table match.

However, in migration of an NW device, since setting logics and setting grammars for realizing the same function are different between a migration source NW device and a migration destination device, there is a problem that the equivalence cannot be determined by simple element matching.

In configuration migration of an NW device in a communication carrier, the conversion time becomes long due to an enormous configuration amount, complicated configuration conversion logics, and the like, and there is a possibility that route switching is not completed during a nighttime period in a service slack period. Therefore, there has been a demand for a method capable of efficiently checking equivalence of configuration data between a migration source NW device and a migration destination NW device.

The present invention has been made in view of the above, and an object thereof is to provide a management system, a management method, and a management program capable of efficiently checking whether configuration data between network devices has been migrated normally.

### Solution to Problem

In order to solve the above-described problems and achieve the object, according to the present invention, there is provided a management system that manages migration from a migration source network device to a migration destination network device, the management system including a conversion device including a first extraction unit that extracts setting content as first summary information for each network function from first setting data for setting an operation of the migration source network device, and a conversion unit that converts a system of the first setting data for setting an operation of the migration source network device into second setting data according to a system of setting data of the migration destination network device, and applies the second setting data to the migration destination network device; and a checking device including a determination unit that determines whether or not migration of the first setting data to the migration destination network device has been performed normally on the basis of the first summary information and third setting data applied to the migration destination network device.

### Advantageous Effects of Invention

According to the present invention, it is possible to efficiently check whether configuration data between network devices has been migrated normally.

### BRIEF DESCRIPTION OF DRAWINGS

FIG. 1 is a block diagram illustrating an example of a configuration of a management system according to an embodiment.

FIG. 2 is a diagram illustrating an example of first summary information.

FIG. 3 is a diagram illustrating an example of a determination result output by a checking device.

FIG. 4 is a block diagram illustrating an example of a configuration of a conversion device illustrated in FIG. 1.

FIG. 5 is a diagram illustrating an example of a data configuration of a system data table.

FIG. 6 is a diagram illustrating an example of a data configuration of a system data table.

FIG. 7 is a diagram illustrating an example of a data configuration of a system data table.

FIG. 8 is a diagram for describing processing of the conversion device and the checking device.

FIG. 9 is a block diagram illustrating an example of a configuration of the checking device illustrated in FIG. 1.

FIG. 10 is a sequence diagram illustrating an example of a processing procedure of a management process according to the embodiment.

FIG. 11 is a sequence diagram illustrating an example of a processing procedure of a checking process according to the embodiment.

FIG. 12 is a diagram illustrating an example of a computer in which the conversion device and the checking device are realized by executing a program.

### DESCRIPTION OF EMBODIMENTS

Hereinafter, embodiments of a management system, a management method, and a management program according to the present application will be described in detail with reference to the drawings. Note that the management system, the management method, and the management program according to the present application are not limited to the embodiments.

### Embodiment

First, an embodiment will be described. In the embodiment, a management system that manages configuration migration from a migration source network (NW) device to a migration destination NW device will be described.

In the embodiment, a case of checking whether configuration data from the migration source NW device to the migration destination NW device has been migrated normally will be described. Note that the configuration data is setting data for setting an operation of an NW device, and has a structure in which a plurality of pieces of associated setting information (parameters) are nested. Different systems of configuration data mean different combinations of parameters to be associated and different nested relationships.

### Configuration of Management System

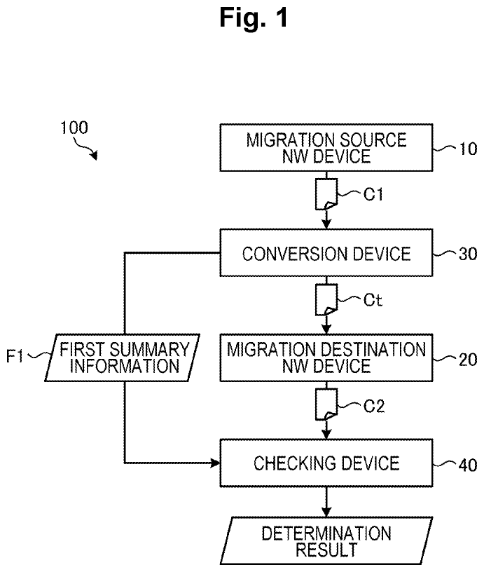

A configuration of a management system according to the embodiment will be described. FIG. 1 is a block diagram illustrating an example of a configuration of a management system according to an embodiment.

As illustrated in FIG. 1, a management system 100 according to the embodiment manages migration of configuration data between a migration source NW device 10 and a migration destination NW device 20. The management system 100 includes a conversion device 30 and a checking device 40.

The conversion device 30 is provided between the migration source NW device 10 and the migration destination NW device 20. The conversion device 30 converts a system of configuration data C1 (first setting data) of the migration source NW device 10 into configuration data Ct (second setting data) according to a system of configuration data of the migration destination NW device 20. The conversion device 30 applies the converted configuration data Ct to the migration destination NW device 20.

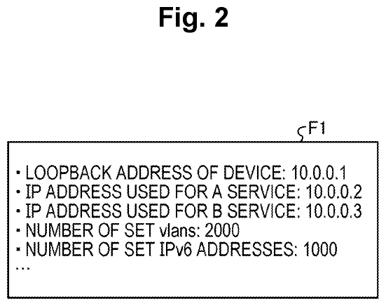

The conversion device 30 extracts setting content for each network function as first summary information from the configuration data C1, and outputs the setting content to the checking device 40. FIG. 2 is a diagram illustrating an example of first summary information F1. As illustrated in FIG. 2, the first summary information F1 describes various types of setting content for each network function extracted from the configuration data C1, such as a loopback address of a device, an IP address used for each service, and the number of set VLANs (vlan).

In a case where a system of configuration data is different between the migration source NW device 10 and the migration destination NW device 20, the conversion device 30 extracts the first summary information from the configuration data C1 and converts the configuration data C1 into the configuration data Ct by using a parameter sheet with which setting content can be associated for each network function.

The checking device 40 checks that the takeover of the setting information has been performed normally between the migration source NW device 10 and the migration destination NW device 20. The checking device 40 uses configuration data C2 (third setting data) applied to the migration destination NW device 20 and the first summary information output by the conversion device 30 as inputs. The checking device 40 extracts setting content for each network function as second summary information from the configuration data C2.

The second summary information is the same setting content for the network function as the first summary information F1, and describes various types of setting content extracted from the configuration data C2.

The checking device 40 determines whether the migration of the configuration data C1 to the migration destination NW device 20 has been performed normally on the basis of the first summary information F1 and the second summary information. The content of the first summary information F1 and the content of the second summary information are collated in units of items, and it is determined whether the first summary information F1 and the second summary information match each other. In a case where the first summary information F1 and the second summary information match, the checking device 40 determines that the migration of the configuration data C1 to the migration destination NW device 20 has been performed normally. On the other hand, in a case where the first summary information F1 and the second summary information do not match, the checking device 40 determines that the migration of the configuration data C1 to the migration destination NW device 20 has not been performed normally.

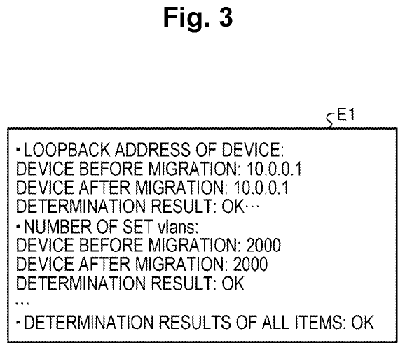

The checking device 40 notifies, for example, a management server of the management system 100 of the determination result. FIG. 3 is a diagram illustrating an example of a determination result output by the checking device 40. As illustrated in FIG. 3, in a determination result E1, a determination result (OK or NG) is described for each item, and for example, determination results of all the items are described at the end.

When systems of the configuration data are different between the migration source NW device 10 and the migration destination NW device 20, the checking device 40 extracts the second summary information from the configuration data C2 and collates the configuration data C1 with the configuration data C2 by using a system data table having the same format as that of a system data table used by the conversion device 30.

### Conversion Device

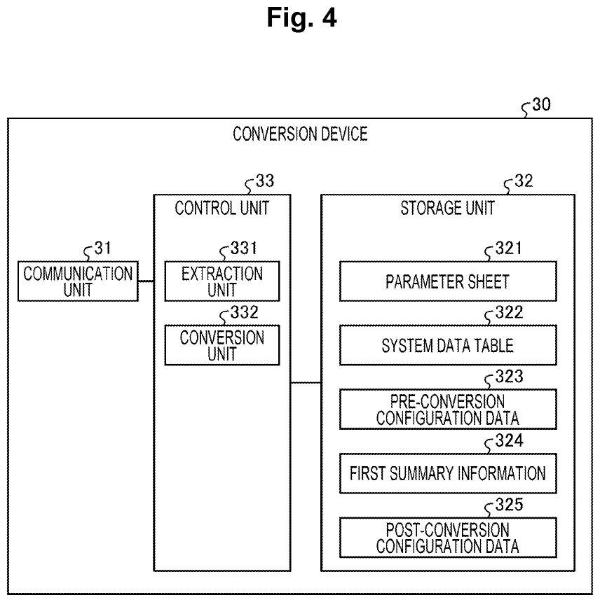

Next, the conversion device 30 will be described. FIG. 4 is a block diagram illustrating an example of a configuration of the conversion device 30 illustrated in FIG. 1. As illustrated in FIG. 4, the conversion device 30 includes a communication unit 31, a storage unit 32, and a control unit 33.

The communication unit 31 is a communication interface that transmits and receives various types of information to and from another device connected via a network or the like. The communication unit 31 is realized by a network interface card (NIC) or the like, and performs communication between another device (for example, the migration source NW device 10, the migration destination NW device 20, or the checking device 40) and the control unit 33 (that will be described later) via an electric communication line such as a local area network (LAN) or the Internet.

The storage unit 32 is a storage device such as a hard disk drive (HDD) or a solid state drive (SSD). The storage unit 32 may be a semiconductor memory capable of rewriting data, such as a random access memory (RAM), a flash memory, or a nonvolatile static random access memory (NVSRAM). The storage unit 32 stores an operating system (OS) and various programs executed by the conversion device 30. The storage unit 32 stores various types of information used for executing the programs.

The storage unit 32 stores a parameter sheet 321, a system data table 322 (first system data table), pre-conversion configuration data 323, first summary information 324, and post-conversion configuration data 325. Note that the storage unit 32 also stores information regarding each format of configuration data of one NW device.

The parameter sheet 321 is used in a case where there is a difference in configuration setting content that are required to be set between the migration source NW device 10 and the migration destination NW device 20 and the difference is eliminated. For example, as a case where there is a difference, there is a case where a unique package (PKG) that does not exist in the migration source NW device 10 exists in the migration destination NW device 20, and it is necessary to set a communication address of the unique PKG in order to enable the unique PKG. In such a case, the conversion device 30 complements information necessary for the operation by describing the communication address of the unique PKG of the migration destination NW device 20 in the parameter sheet 321.

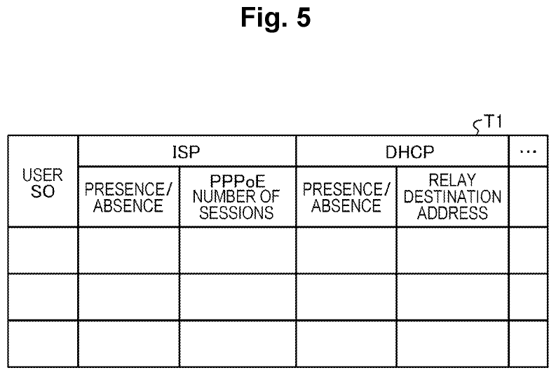

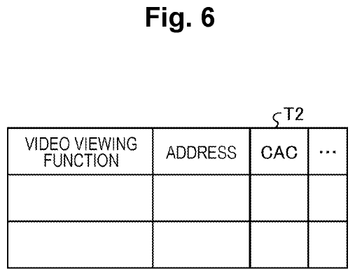

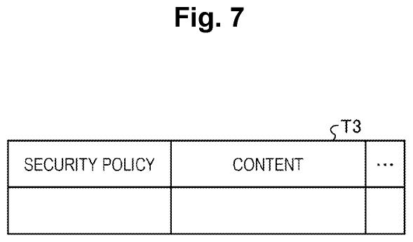

The system data table 322 has a format corresponding to each network function. FIGS. 5 to 7 are diagrams illustrating an example of a data configuration of a system data table. In a system data table T1 in FIG. 5, for each user, setting content can be associated with an item of each service provided to the user. In the system data table T1, a cell corresponding to an item including the presence or absence of an Internet service provider (ISP) or the like and an item including the presence or absence of a dynamic host configuration protocol (DHCP) or the like is provided for each user. In a system data table T2 in FIG. 6, an address or the like can be associated according to a function provided to a user. In a system data table T3 in FIG. 7, content of security can be associated with each security policy.

The pre-conversion configuration data 323 is, for example, configuration data (for example, the configuration data C1) of the migration source NW device 10. The first summary information 324 is, for example, the first summary information F1, and is information extracted from the configuration data C1 by the extraction unit 331 (that will be described later). The post-conversion configuration data 325 is, for example, configuration data (for example, the configuration data Ct) applied to the migration destination NW device 20, converted by the conversion unit 332 (that will be described later).

The control unit 33 controls the entire conversion device 30. The control unit 33 is, for example, an electronic circuit such as a central processing unit (CPU) or a micro processing unit (MPU), or an integrated circuit such as an application specific integrated circuit (ASIC) or a field programmable gate array (FPGA). The control unit 33 includes an internal memory storing programs and control data defining various processing procedures and performs each process by using the internal memory. The control unit 33 functions as various processing units by operating various programs. The control unit 33 includes an extraction unit 331 (first extraction unit) and a conversion unit 332.

The extraction unit 331 extracts setting content (for example, a parameter) for each network function as first summary information from the configuration data C1. From the configuration data C1, the extraction unit 331 extracts, as the first summary information, user information of a user who receives a predetermined service via the migration source NW device 10, specific information of the migration source NW device 10, and/or the number of networks and connection destinations set in the migration source NW device.

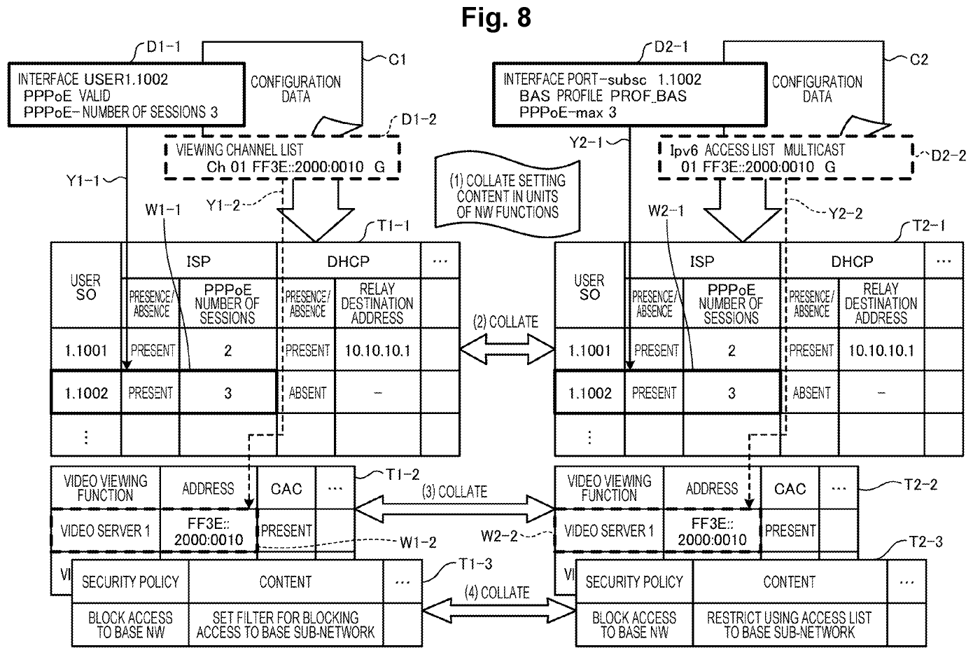

The extraction unit 331 extracts setting content for each network function from the configuration data C1, and describes the extracted setting content in a corresponding cell of the system data table 322 in a format corresponding to each network function. FIG. 8 is a diagram illustrating processing of the conversion device 30 and the checking device 40.

As illustrated in FIG. 8, for example, the extraction unit 331 describes setting content D1-1 of the ISP for “interface USER 1.1002” from the configuration data C1 in each cell W1-1 corresponding to the setting content in the system data table T1 (refer to FIG. 5) (arrow Y1-1). The extraction unit 331 describes, on the basis of the configuration data C1, each piece of setting content D1-2 for the function “viewing channel list” to be provided to a user in each cell W1-2 corresponding to this setting content in the system data table T2 (refer to FIG. 6) (arrow Y2-1).

As described above, the extraction unit 331 extracts each piece of setting content associated with a network function from the configuration data C1 and describes the setting content in a corresponding cell of the system data tables T1 to T3, to create system data tables T1-1, T1-2, and T1-3 in which the setting content of the configuration data C1 is described for each network function. The extraction unit 331 sets the system data tables T1-1, T1-2, and T1-3 as the first summary information 324 without any change, or sets, as the first summary information, user information of a user who receives a predetermined service via the migration source NW device 10, specific information of the migration source NW device 10, and/or the information in which the number of networks and connection destinations set in the migration source NW device are compiled on the basis of the system data tables T1-1, T1-2, and T1-3. The extraction unit 331 outputs the first summary information 324 to the checking device 40.

The conversion unit 332 converts the system of the configuration data C1 into the configuration data Ct according to the system of the setting data of the migration destination NW device, and applies the configuration data Ct to the migration destination NW device 20.

In a case where the systems of the configuration data are different between the migration source NW device 10 and the migration destination NW device 20, the conversion unit 332 generates the configuration data Ct by disposing the setting content described in each cell of the system data tables T1-1, T1-2, and T1-3 according to the system of the configuration data applied to the migration destination NW device 20.

### Checking Device

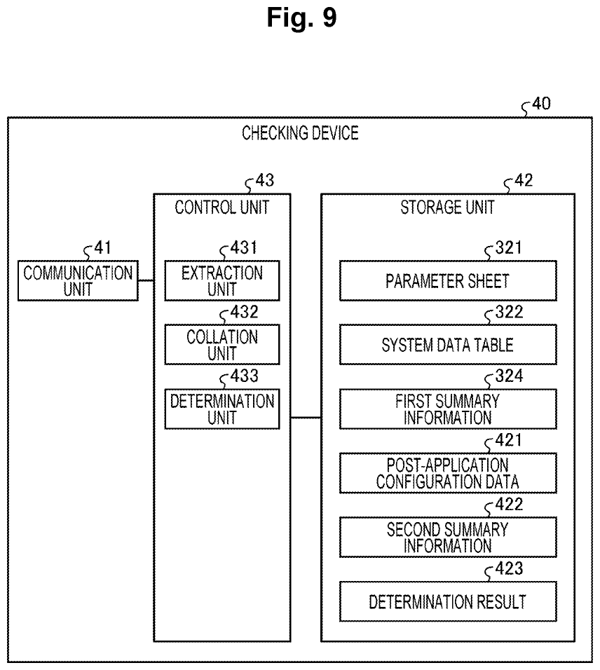

Next, the checking device 40 will be described. FIG. 9 is a block diagram illustrating an example of a configuration of the checking device 40 illustrated in FIG. 1. As illustrated in FIG. 9, the checking device 40 includes a communication unit 41, a storage unit 42, and a control unit 43.

The communication unit 41 is a communication interface that transmits and receives various types of information to and from another device connected via a network or the like. The communication unit 41 is implemented by an NIC or the like, and performs communication between another device (for example, the migration destination NW device 20 or the conversion device 30) and the control unit 43 (that will be described later) via an electric communication line such as a LAN or the Internet.

The storage unit 42 is a storage device such as an HDD or an SSD. Note that the storage unit 42 may be a semiconductor memory capable of rewriting data, such as a RAM, a flash memory, or an NVSRAM. The storage unit 42 stores an OS and various programs executed by the checking device 40. The storage unit 42 stores various types of information used for executing the programs.

The storage unit 42 stores a parameter sheet 321, a system data table 322, first summary information 324 (for example, the system data tables T1-1, T1-2, and T1-3), post-application configuration data 421 (for example, the configuration data C2) applied to the migration destination NW device 20, second summary information 422 created by the extraction unit 431 (that will be described later), and a determination result 423 (for example, the determination result E1) from the determination unit 433.

The control unit 43 controls the entire checking device 40. The control unit 43 is, for example, an electronic circuit such as a CPU or an MPU, or an integrated circuit such as an ASIC or an FPGA. The control unit 43 includes an internal memory storing programs and control data defining various processing procedures, and executes each process by using the internal memory. The control unit 43 functions as various processing units by operating various programs. The control unit 43 includes an extraction unit 431 (second extraction unit), a collation unit 432, and a determination unit 433.

The extraction unit 431 extracts setting content for each network function as second summary information from the configuration data C2. From the configuration data C2, the extraction unit 431 extracts, as the second summary information, user information of a user who receives a predetermined service via the migration destination NW device 20, specific information of the migration destination NW device 20, and/or the number of networks and connection destinations set in the migration destination NW device 20.

The extraction unit 431 extracts setting content for each network function from the configuration data C2, and describes the extracted setting content in a corresponding cell of the system data table 322 in a format corresponding to each network function. The checking device 40 uses the system data table 322 (second system data table) having the same format as that of the system data table 322 used by the conversion device 30.

As illustrated in FIG. 8, for example, the extraction unit 431 describes setting content D2-1 of the ISP for “interface port-subsc 1.1002” from the configuration data C2 in each cell W2-1 corresponding to the setting content in the system data table TI (refer to FIG. 5) (arrow Y2-1). The extraction unit 431 describes, on the basis of the configuration data C2, each piece of setting content D2-2 for the function “Ipv6 access list multicast” provided to a user in each cell W2-2 (arrow Y2-2) corresponding to the setting content in the system data table T2 (refer to FIG. 6).

In this manner, the extraction unit 431 extracts each setting content associated with each network function from the configuration data C2 and describes the setting content in the corresponding cell of the system data tables T1 to T3, to create the system data tables T2-1, T2-2, and T2-3 in which the setting content of the configuration data C2 is described for each network function. The extraction unit 431 sets these system data tables T2-1, T2-2, and T2-3 as the second summary information 422 without any change, or sets, as the second summary information, user information of a user who receives a predetermined service via the migration source NW device 10, specific information of the migration source NW device 10, and/or information in which the number of networks and connection destinations set in the migration source NW device are compiled on the basis of the system data tables T2-1, T2-2, and T2-3.

The collation unit 432 collates the first summary information 324 with the second summary information 422. As illustrated in FIG. 8, the system data tables T1-1, T1-2, and T1-3 that are the first summary information 324 and the system data tables T2-1, T2-2, and T2-3 that are the second summary information 422 are system data tables having the same format, and setting content is described in each cell in units of NW functions. Therefore, the collation unit 432 collates the pieces of setting content in units of NW functions by comparing the pieces of described content of the cells at the same position in the system data tables T1-1, T1-2, and T1-3 and the system data tables T2-1, T2-2, and T2-3 ((1) in FIG. 8).

For example, the collation unit 432 collates the pieces of setting content described in the cell W1-1 of the system data table T1-1 and the cell W2-1 of the system data table T2-1 ((2) in FIG. 8). The collation unit 432 collates the pieces of setting content described in the cell W1-2 of the system data table T1-2 and the cell W2-2 of the system data table T2-2 ((3) in FIG. 8). Similarly, the collation unit 432 collates the pieces of described content between cells at the same position in the system data table T1-3 and the system data table T2-3 ((4) in FIG. 8). The collation unit 432 outputs the collation result to the determination unit 433.

The determination unit 433 determines whether the migration of the configuration data C1 to the migration destination NW device 20 has been performed normally on the basis of the first summary information 324 and the second summary information 422.

In a case where the first summary information 324 and the second summary information 422 match, the determination unit 433 determines that the migration of the configuration data C1 to the migration destination NW device 20 has been performed normally on the basis of the collation result from the collation unit 432.

Specifically, in a case where the pieces of content in the system data tables T1-1, T1-2, and T1-3 that are the first summary information 324 and the system data tables T2-1, T2-2, and T2-3 that are the second summary information 422 match in any of the tables, the determination unit 433 determines that the migration of the configuration data C1 to the migration destination NW device 20 has been performed normally. In this case, as illustrated in the determination result E1 in FIG. 3, the determination unit 433 sets the determination results of all the items to “OK”.

On the other hand, in a case where the first summary information 324 and the second summary information 422 do not match, the determination unit 433 determines that the migration of the configuration data C1 to the migration destination NW device 20 has not been performed normally.

For example, in a case where the pieces of setting content described in the cell W1-2 of the system data table T1-1 and the cell W2-2 of the system data table T2-2 do not match in the system data tables T1-1, T1-2, and T1-3 and the system data tables T2-1, T2-2, and T2-3, the determination unit determines 433 that an identification number and an address of the server are not migrated normally to the migration destination NW device 20 in the video viewing function in the configuration data C1. In this case, the determination unit 433 sets a determination result of the migration of the identification number and the address of the server in the video viewing function to “NG”.

### Management Process

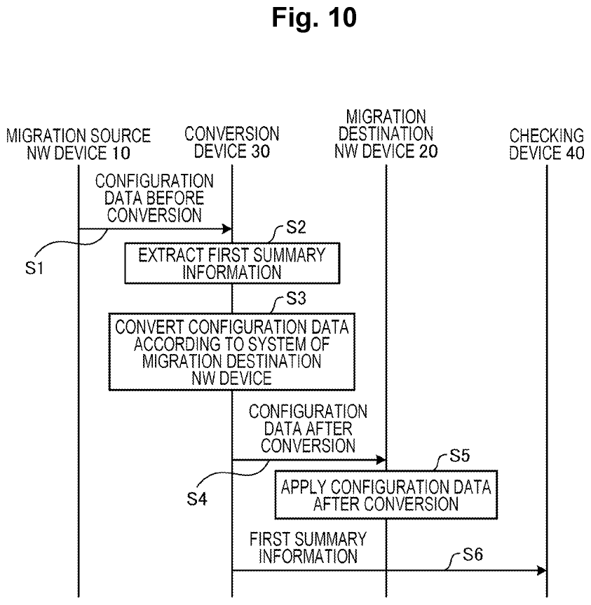

Next, a management process executed by the management system 100 will be described. FIG. 10 is a sequence diagram illustrating an example of a processing procedure of the management process according to the embodiment.

As illustrated in FIG. 10, in a case where the configuration is migrated from the migration source NW device 10 to the migration destination NW device 20, first, the conversion device 30 receives the configuration data C1 before conversion from the migration source NW device 10 (step S1). The conversion device 30 extracts setting content for each network function as first summary information from the configuration data C1 (step S2).

The conversion device 30 converts the configuration data C1 into configuration data Ct according to a system of the configuration data applied to the migration destination NW device 20 (step S3). The conversion device 30 transmits the configuration data Ct after conversion to the migration destination NW device 20 (step S4), and applies the configuration data Ct to the migration destination NW device 20 (step S5). The conversion device 30 transmits the first summary information to the checking device 40 (step S6).

### Checking Process

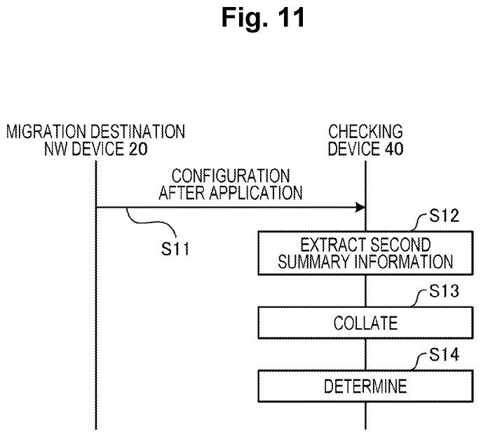

Next, a checking process executed by the management system 100 will be described. FIG. 11 is a sequence diagram illustrating an example of a processing procedure of the checking process in the embodiment.

As illustrated in FIG. 11, the checking device 40 receives the configuration data C2 applied to the migration destination NW device 20 from the migration destination NW device 20 (step S11). Note that the checking device 40 has already received the first summary information transmitted from the conversion device 30.

The checking device 40 extracts setting content as second summary information for each network function from the configuration data C2 (step S12). The checking device 40 collates the first summary information with the second summary information (step S13), and determines whether the migration of the configuration data C1 to the migration destination NW device 20 has been performed normally (step S14).

### Effects of Embodiment

As described above, in the embodiment, the conversion device 30 extracts the setting content as the first summary information for each network function from the configuration data C1 of the migration source NW device 10. In the embodiment, the checking device 40 extracts the setting content as the second summary information for each network function from the configuration data C2 applied to the migration destination NW device 20. In the embodiment, the checking device 40 determines whether migration of the configuration data C1 to the migration destination NW device 20 has been performed normally on the basis of the first summary information and the second summary information.

As described above, the checking device 40 compares the pieces of setting content in units of network functions in the configuration data C1 and C2 to determine whether the migration of the configuration data C1 to the migration destination NW device 20 has been performed normally. Since the configuration data C1 and the configuration data C2 are data for setting an operation of an NW device, the checking device 40 can appropriately determine the equivalence between the configuration data C1 and the configuration data C2 by collating the pieces of setting content for realizing the NW function. In the embodiment, since it is not necessary to perform all-row comparison on the configuration data C1 and the configuration data C2, it is possible to efficiently check whether or not the configuration data between the NW devices has been migrated normally compared with a case where all-row comparison is performed.

As described above, in the embodiment, since the normality checking of the configuration migration can be efficiently and appropriately executed, a configuration migration normality checking process can be speeded up. In the management system 100, as the efficiency of the normality checking of the configuration migration is improved, a load of the configuration migration normality checking process can be reduced compared with the related art.

Note that the checking device 40 may collate the configuration data C2 applied to the migration destination NW device 20 with the first summary information 324 to determine whether the migration of the configuration data C1 to the migration destination NW device 20 has been performed normally. In a case where the first summary information 324 matches the setting content of the configuration data C2, the checking device 40 determines that the migration of the configuration data C1 to the migration destination NW device 20 has been performed normally. In a case where the first summary information 324 does not match the setting content of the configuration data C2, the checking device 40 determines that the migration of the configuration data C1 to the migration destination NW device 20 has not been performed normally. The checking device 40 does not need to create the second summary information 422 when collating the first summary information 324 with the setting content of the configuration data C2.

### System Configuration of Embodiment

Each constituent of the conversion device 30 and the checking device 40 is functionally conceptual, and does not necessarily need to be physically configured as illustrated. That is, a specific form of distribution and integration of the functions of the conversion device 30 and the checking device 40 is not limited to the illustrated form, and all or some thereof can be functionally or physically distributed or integrated in any unit according to various loads, usage conditions, and the like.

All or any of the respective processes performed in the conversion device 30 and the checking device 40 may be realized by a CPU, a graphics processing unit (GPU), and a program analyzed and executed by the CPU and the GPU. Each process performed in the conversion device 30 and the checking device 40 may be realized by hardware using wired logic.

Among the processes described in the embodiment, all or some of the processes described as being automatically performed may be manually performed. Alternatively, all or some of the processes described as being manually performed may be automatically performed by using a known method. The above-described and illustrated processing procedures, control procedures, specific names, and information including various types of data and parameters can be appropriately changed unless otherwise specified.

### Program

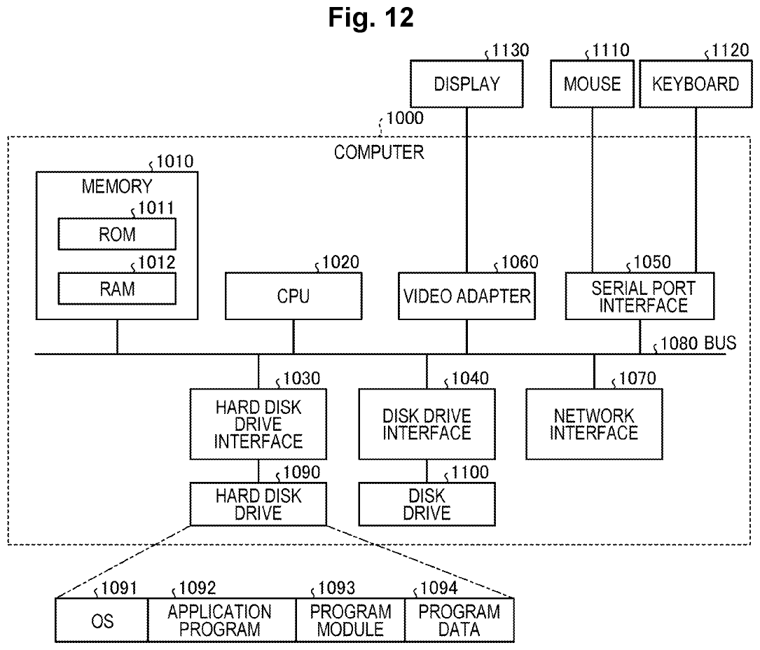

FIG. 12 is a diagram illustrating an example of a computer in which the conversion device 30 and the checking device 40 are realized by executing a program. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These units are connected to each other via a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, the program defining each process of the conversion device 30, the checking device 40, and the migration source NW device 210 is installed as a program module 1093 in which codes executable by the computer 1000 are written. The program module 1093 is stored in, for example, the hard disk drive 1090. For example, the program module 1093 for executing processes similar to those of the functional configurations of the conversion device 30, the checking device 40, and the migration source NW device 210 is stored in the hard disk drive 1090. Note that the hard disk drive 1090 may be replaced with a solid state drive (SSD).

The setting data used in the processing of the above-described embodiment is stored as the program data 1094 in, for example, the memory 1010 or the hard disk drive 1090. The CPU 1020 reads the program module 1093 and the program data 1094 stored in the memory 1010 and the hard disk drive 1090 into the RAM 1012 as necessary and executes the program module 1093 and the program data 1094.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). The program module 1093 and the program data 1094 may be read by the CPU 1020 from another computer via the network interface 1070.

Although the embodiment to which the invention made by the present inventors is applied has been described above, the present invention is not limited by the description and drawings constituting a part of the disclosure of the present invention according to the present embodiment. That is, other embodiments, examples, operation techniques, and the like made by those skilled in the art or the like on the basis of the present embodiment are all included in the scope of the present invention.

### REFERENCE SIGNS LIST

10 Migration source NW device
20 Migration destination NW device
30 Conversion device
31, 41 Communication unit
32, 42 Storage unit
33, 43 Control unit
40 Checking device
100 Management system
331, 431 Extraction unit
332 Conversion unit
432 Collation unit
433 Determination unit

1. A management system configured to manage migration from a migration source network device to a migration destination network device, the management system comprising:
a conversion device including:
a first extraction unit, comprising one or more processors, configured to extract setting content as first summary information for each network function from first setting data for setting an operation of the migration source network device, and
a conversion unit, comprising one or more processors, configured to convert a system of the first setting data for setting an operation of the migration source network device into second setting data according to a system of setting data of the migration destination network device, and apply the second setting data to the migration destination network device; and
a checking device including:
a determination unit, comprising one or more processors, configured to determine whether or not migration of the first setting data to the migration destination network device has been performed normally on the basis of the first summary information and third setting data applied to the migration destination network device.

2. The management system according to claim 1, wherein the first extraction unit is configured to extract, as the first summary information, user information of a user configured to receive a predetermined service via the migration source network device, specific information of the migration source network device, and/or the number of networks and connection destinations set in the migration source network device from the first setting data.

3. The management system according to claim 1, wherein the determination unit is configured to determine that the migration of the first setting data to the migration destination network device has been performed normally in a case where the first summary information is configured to match setting content of the third setting data, and determine that the migration of the first setting data to the migration destination network device has not been performed normally in a case where the first summary information does not match the setting content of the third setting data.

4. The management system according to claim 3, wherein
the checking device further includes a second extraction unit configured to extract, as second summary information, user information of a user configured to receive a predetermined service via the migration destination network device, specific information of the migration destination network device, and/or the number of networks and connection destinations set in the migration destination network device from the third setting data, and
the determination unit is configured to determine that the migration of the first setting data to the migration destination network device has been performed normally in a case where the first summary information is configured to match the second summary information, and determine that the migration of the first setting data to the migration destination network device has not been performed normally in a case where the first summary information does not match the second summary information.

5. The management system according to claim 4, wherein
the first extraction unit is configured to extract setting content for each network function from the first setting data, and describe the extracted setting content in a corresponding cell of a first system data table in a format corresponding to each network function,
the second extraction unit is configured to extract setting content for each network function from the third setting data, and describe the extracted setting content in a corresponding cell of a second system data table having the same format as the format of the first system data table, and
the determination unit is configured to determine whether or not migration of the first setting data to the migration destination network device has been performed normally on the basis of the described content in each cell of the first system data table and the described content in each cell of the second system data table.

6. A management method executed by a management system configured to include a conversion device and a checking device and manage migration from a migration source network device to a migration destination network device, the management method comprising:
causing the conversion device to extract setting content as first summary information for each network function from first setting data for setting an operation of the migration source network device;
causing the conversion device to convert a system of the first setting data for setting an operation of the migration source network device into second setting data according to a system of setting data of the migration destination network device, and applying the second setting data to the migration destination network device; and
causing the checking device to determine whether or not migration of the first setting data to the migration destination network device has been performed normally on the basis of the first summary information and third setting data applied to the migration destination network device.

7. A non-transitory computer readable medium storing a program, wherein execution of the program causes a computer to execute operations comprising:
extracting setting content as first summary information for each network function from first setting data for setting an operation of a migration source network device;
converting a system of the first setting data for setting an operation of the migration source network device into second setting data according to a system of setting data of a migration destination network device, and applying the second setting data to the migration destination network device; and
determining whether or not migration of the first setting data to the migration destination network device has been performed normally on the basis of the first summary information and third setting data applied to the migration destination network device.
